(19) United States
(12) Patent Application Publication
(10) Pub. No.: US 2009/0052312 A1
(43) Pub. Date: Feb. 26, 2009

(54) RECORDING APPARATUS, REPRODUCING APPARATUS, RECORDING METHOD, REPRODUCING METHOD, AND RECORDING MEDIUM

(75) Inventors: Kunihiko HAYASHI, Kanagawa (JP); Toshihiro Horigome, Kanagawa (JP); Goro Fujita, Kanagawa (JP); Kimihiro Saito, Saitama (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corparation, Tokyo (JP)

(21) Appl. No.: 12/131,494

(22) Filed: Jun. 2, 2008

(30) Foreign Application Priority Data
Jun. 8, 2007 (JP) 2007-152558

(51) Int. Cl. G11B 7/00

(52) U.S. Cl. 369/275.3; G9B/7

(57) ABSTRACT

A recording apparatus for recording data on a recording medium having at least one recording layer, includes a loading unit and a recorder unit. On the loading unit, the recording medium is capable of being loaded. The recorder unit is configured to cause the at least one recording layer a physical change to collectively record a plurality of pieces of data on the at least one recording layer of the recording medium loaded on the loading unit, in a thickness direction of the at least one recording layer, such that the physical change of the at least one recording layer is capable of being detected at one time when the recording medium is reproduced.

### CROSS REFERENCES TO RELATED APPLICATIONS

The present invention contains subject matter related to Japanese Patent Application JP 2007-152558 filed in the Japanese Patent Office on Jun. 8, 2007, the entire contents of which being incorporated herein by reference.

### BACKGROUND OF THE INVENTION

1. Field of the Invention

The present invention relates to a recording apparatus and a recording method for recording data on a recording medium using a hologram, a reproducing apparatus and a reproducing method for reproducing the data, and the recording medium.

2. Description of the Related Art

In the past, there has been known a technology employing a hologram as a recording mark for a recording medium such as an optical disc. This method is useful in, for example, the following recording system. That is, a laser light is split into two laser lights, which are then condensed on a recording position on a recording medium. As a result, interference of the lights occurs. A shape of the interference pattern is recorded, and a portion where the recording is set as a reflection portion.

As the above-mentioned recording system, there have been developed a system in which an optical disc is located between two optical systems, and a system in which two optical systems are provided at one side of an optical disc having a reflection surface formed therein. In both the systems, it is necessary to perform control in at least four directions, i.e., optical axis directions of the two optical systems (focus directions) and directions orthogonal to the optical axes (tracking directions).

In this case, for example, according to R. R. McLeod et al., “Microholographic multilayer optical disk data storage”, Appl. Opt., Vol. 44, 2005, pp. 3197-3207 (hereinafter, referred to as Non-patent Document 1), information can be recorded on a medium in a layered manner. That is, information generally recorded on the same number of optical discs as the layers can be collectively recorded on the medium.

Further, Japanese Patent Application Laid-open No. 2005-339801 (paragraph 0045, FIG. 1; hereinafter referred to as Patent Document 1) describes a method employing a general multilayer disc having an address surface (signal) for each layer on which information is recorded.

### SUMMARY OF THE INVENTION

Although the technology of Non-patent Document 1 enables a larger capacity of an optical disc, a data transfer rate thereof is no different than that of a past optical disc. So it takes much time to record/read out a large amount of data, which is problematic.

In general, an optical disc of a CLV (Constant Linear Velocity) type is excellent in recording density. Thus, an optical disc of the CLV type is preferably used. According to the CLV system, recording density at an inner diameter side of an optical disc is the same as that at an outer diameter side, and rpm of the optical disc is controlled in order to read out data at a constant speed. However, the CLV system, i.e., a recording system for controlling rpm of an optical disc depending on a read-out position, cannot address a case where recording/reproduction is performed on different positions in one recording layer with multibeams.

Further, according to the technology of Patent Document 1, because a plurality of recording layers are employed, in a case where a recording medium is inclined, there is a fear in that, as the address surface is distant from the recording layer, a light irradiation position on the address surface and a light irradiation position on the recording surface may be displaced.

To address the above-mentioned problems, in a case where the multilayer disc of Patent Document 1, having an address signal for each layer, is applied to the hologram disc of Non-patent Document 1, the structure of the hologram disc becomes complicated, the cost thereof increases, and, when an address area exists between layers, a recording light and a reference light are affected by the address area to deteriorate S/N (signal to noise ratio) of a recording signal, which are problematic.

In view of the above, there is a need for a recording apparatus, a reproducing apparatus, a recording method, a reproducing method, and a recording medium, which are excellent in recording/reproducing a large amount of data.

In view of the above, according to an embodiment of the present invention, a recording apparatus for recording data on a recording medium having at least one recording layer, includes a loading unit and a recorder unit. On the loading unit, the recording medium is capable of being loaded. The recorder unit is configured to cause the at least one recording layer a physical change to collectively record a plurality of pieces of data on the at least one recording layer of the recording medium loaded on the loading unit, in a thickness direction of the at least one recording layer, such that the physical change of the at least one recording layer is capable of being detected at one time when the recording medium is reproduced.

According to this embodiment, the at least one recording layer is caused a physical change to collectively record a plurality of pieces of data on the at least one recording layer of the recording medium, in a thickness direction of the at least one recording layer, such that the physical change of the at least one recording layer is capable of being detected at one time when the recording medium is reproduced. So, the plurality of pieces of data can be simultaneously recorded and, in addition, collectively detected during reproduction. Recording/reproduction of a large amount of data is thus enabled.

In this embodiment, the recorder unit is configured to cause the at least one recording layer the physical change by forming holograms, to record the plurality of pieces of data. Therefore, a laser light is split into a plurality of laser lights, which are then condensed on a recording portion on the recording medium. As a result, interference of the lights occurs. By recording a shape of the interference pattern, the hologram serving as a recording mark can readily be formed.

In this embodiment, each of the plurality of pieces of data is expressed by one of hologram presence and hologram absence. Therefore, binary data can be recorded with the hologram.

In this embodiment, the plurality of pieces of data collectively recorded constitute one information unit. Therefore, for example, data is recorded on a recording portion having three layers, to thereby express data of three bits.

In this embodiment, the recorder unit is configured to cause the at least one recording layer the physical change by subjecting the at least one recording layer to thermal processing to form the holograms, to record the plurality of pieces of data. Therefore, for example, by heating the recording portion, a refractive index of the recording layer is changed, to thereby readily record data on the recording portion.

In this embodiment, the recorder unit is configured to cause the at least one recording layer the physical change by focusing a light on the recording medium at a higher light focusing rate than a light focusing rate in a case of reproducing the plurality of pieces of data, to record the plurality of pieces of data. Therefore, during reproduction, the plurality of pieces of data can be collectively reproduced.

In this embodiment, the recorder unit includes a laser light source for the plurality of pieces of data collectively recorded. Therefore, the structure can be simplified, the adjustment can be readily performed, and the number of components can be reduced.

In this embodiment, the recorder unit includes a laser light source configured to emit a laser light, an optical system configured to focus the laser light on the recording medium, and a drive control unit for the optical system. The drive control unit is configured to move a focus point of the laser light at high speed to collectively record the plurality of pieces of data on the recording medium. Therefore, the number of the laser light source can be reduced and the cost can be reduced. For example, the optical system may include an objective lens, and the drive control unit may be configured to move the objective lens at high speed to move the focus point at high speed. Alternatively, the optical system may include a liquid lens serving as an objective lens, and the drive control unit may be configured to expand/contract the liquid lens at high speed to move the focus point at high speed. Alternatively, the optical system may include a high-speed modulator, and the drive control unit may be configured to drive the high-speed modulator to move the focus point at high speed.

According to another embodiment of the present invention, a reproducing apparatus for reproducing data recorded on at least one recording layer of a recording medium, include a loading unit and a detection unit. On the loading unit, the recording medium is capable of being loaded. The at least one recording layer of the recording medium is caused a physical change such that a plurality of pieces of data are collectively recorded on the at least one recording layer in a thickness direction of the at least one recording layer. The detection unit is configured to simultaneously read the plurality of pieces of data, and configured to detect the physical change of the at least one recording layer collectively recorded with the plurality of pieces of data having been read.

According to this embodiment, since the at least one recording layer of the recording medium is caused a physical change such that a plurality of pieces of data are collectively recorded on the at least one recording layer in a thickness direction of the at least one recording layer, and the detection unit is configured to simultaneously read the plurality of pieces of data, and configured to detect the physical change of the at least one recording layer collectively recorded with the plurality of pieces of data having been read, the plurality of pieces of data can be collectively detected during recording. Therefore, it is possible to read out a large amount of data.

In this embodiment, each of the plurality of pieces of data, the plurality of pieces of data being collectively recorded on the at least one recording layer of the recording medium in the thickness direction of the at least one recording layer, is expressed by one of hologram presence and hologram absence. Further, the detection unit is configured to detect the physical change by detecting a signal intensity, to detect, based on the signal intensity, the plurality of pieces of data each expressed by the one of hologram presence and hologram absence. Thus, the detection unit is configured to detect the physical change by detecting a signal intensity, to detect, based on the signal intensity, the plurality of pieces of data each expressed by the one of hologram presence and hologram absence, to thereby reproduce the data.

In this embodiment, the detection unit includes a laser light source configured to emit a laser light, and an optical system configured to focus the laser light on the recording medium such that the laser light is focused on the plurality of pieces of data collectively recorded on the at least one recording layer of the recording medium, in the thickness direction of the at least one recording layer. Thus, the laser light is focused on the recording medium such that the laser light is focused on the plurality of pieces of data collectively recorded on the at least one recording layer of the recording medium, in the thickness direction of the at least one recording layer, to thereby reproduce the data.

In this embodiment, the recording medium includes a plurality of tracks. Further, the optical system focuses the laser light on the plurality of pieces of data collectively recorded on the at least one recording layer such that one of the plurality of tracks of the recording medium is focused on. Thus, the data can be correctly read out from a predetermined track.

According to another embodiment of the present invention, a recording method of recording data on a recording medium including at least one recording layer, includes loading the recording medium on a loading unit, and collectively recording a plurality of pieces of data on the at least one recording layer of the recording medium loaded on the loading unit, in a thickness direction of the at least one recording layer, such that a physical change of the at least one recording layer is capable of being detected at one time when the recording medium is reproduced.

According to this embodiment, a plurality of pieces of data are collectively recorded on the at least one recording layer of the recording medium, in a thickness direction of the at least one recording layer, such that a physical change of the at least one recording layer is capable of being detected at one time when the recording medium is reproduced. So, the plurality of pieces of data can be simultaneously recorded and, in addition, collectively detected during reproduction. Recording/reproduction of a large amount of data is thus enabled.

According to another embodiment of the present invention, a reproducing method of reproducing data recorded on at least one recording layer of a recording medium, includes loading the recording medium on a loading unit, the at least one recording layer of the recording medium being caused a physical change such that a plurality of pieces of data are collectively recorded on the at least one recording layer in a thickness direction of the at least one recording layer, and simultaneously reading the plurality of pieces of data, and detecting the physical change of the at least one recording layer collectively recorded with the plurality of pieces of data having been read.

According to this embodiment, since the plurality of pieces of data collectively recorded on the at least one recording layer in a thickness direction of the at least one recording layer are simultaneously read, and the physical change of the at least one recording layer collectively recorded with the plurality of pieces of data having been read is detected, the plurality of pieces of data can be collectively detected during reproduction. Therefore, it is possible to read out a large amount of data.

According to another embodiment of the present invention, a recording medium includes at least one recording layer. On the at least one recording layer, a plurality of pieces of data are capable of being collectively recorded, in a thickness direction of the at least one recording layer, such that a physical change of the at least one recording layer is capable of being detected at one time when the recording medium is reproduced.

According to this embodiment, with the use of the above-mentioned reproducing apparatus, a large amount of data recorded on the recording medium can be reproduced at high speed.

In this embodiment, the plurality of pieces of data, the plurality of pieces of data being collectively recorded on the at least one recording layer in the thickness direction of the at least one recording layer such that the physical change of the at least one recording layer is capable of being detected at one time when the recording medium is reproduced, constitute one information unit. Therefore, data of three bits can be reproduced at one time.

As described above, according to the embodiments of the present invention, a large amount of data can be recorded/read out.

These and other objects, features and advantages of the present invention will become more apparent in light of the following detailed description of best mode embodiments thereof, as illustrated in the accompanying drawings.

### BRIEF DESCRIPTION OF DRAWINGS

FIG. 1 is a block diagram showing a hologram recording/reproducing apparatus, which is an optical disc apparatus, according to a first embodiment of the present invention;

FIG. 2 is a block diagram showing optical systems of an optical pickup of the optical disc apparatus;

FIG. 3 is an optical path diagram (I) of a blue light beam during recording;

FIG. 4 is an optical path diagram (II) of another blue light beam during recording;

FIG. 5 is a sectional view of an optical disc on which holograms are formed;

FIGS. 6A to 6H are diagrams illustrating a recording system of three-bit information in each recording portion of the optical disc of FIG. 5;

FIG. 7 is a diagram showing a relationship between a numerical value expressed by three bits and an intensity of a reproduction light during reproduction;

FIG. 8 is an optical path diagram of a blue light beam from a laser diode during reproduction;

FIG. 9 is an optical path diagram of another blue light beam from another laser diode during reproduction;

FIG. 10 is a block diagram showing in detail a structure of a position control optical system of FIG. 2;

FIG. 11 is a block diagram showing in detail a structure of a first information optical system of FIG. 2;

FIG. 12 is a block diagram showing optical systems of an optical pickup of an optical disc apparatus according to a second embodiment of the present invention;

FIG. 13 is a block diagram showing optical systems of an optical pickup of an optical disc apparatus according to a third embodiment of the present invention;

FIG. 14 is a diagram illustrating a light spot during recording/reproduction according to the third embodiment of the present invention; and

FIG. 15 is a block diagram showing optical systems of an optical pickup of an optical disc apparatus according to a fourth embodiment of the present invention.

### DESCRIPTION OF PREFERRED EMBODIMENTS

Hereinafter, embodiments of the present invention will be described with reference to the attached drawings.

### First Embodiment

(Structure of a Hologram Recording/Reproducing Apparatus)

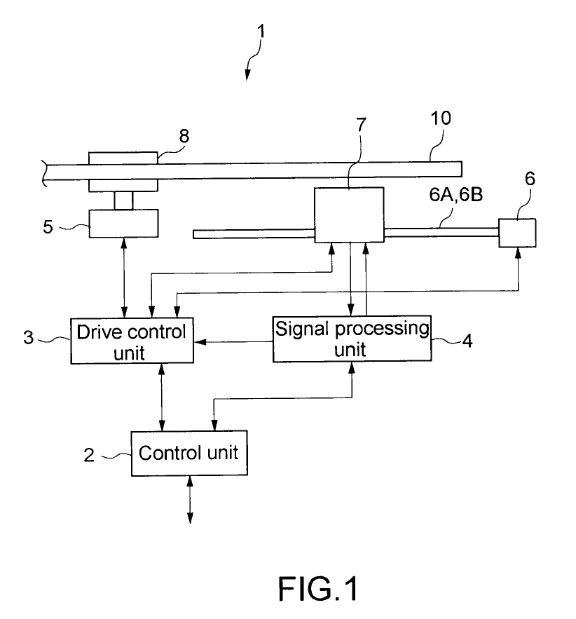

FIG. 1 is a block diagram showing a hologram recording/reproducing apparatus, which is an optical disc apparatus, according to a first embodiment of the present invention.

As shown in FIG. 1, the hologram recording/reproducing apparatus, denoted by reference numeral 1, includes a control unit 2, a drive control unit 3, a signal processing unit 4, a spindle motor 5, a sled motor 6, an optical pickup 7, and a loading unit B. The control unit 2 controls the hologram recording/reproducing apparatus 1. The control unit 2 controls the drive control unit 3 and the signal processing unit 4. An optical disc 10 is loaded on the loading unit 8.

As shown in FIG. 1, in the state where the optical disc 10 is loaded, the control unit 2 receives a recording/reproducing command and recording/reproducing address information from an external device (not shown) outside of the recording/reproducing apparatus 1, supplies a drive command to the drive control unit 3, and supplies the recording/reproducing command to the signal processing unit 4. Further, the control unit 2 receives reproducing information from the signal processing unit 4 and transmits the reproducing information to the external device (not shown).

In response to the drive command, the drive control unit 3 controls the spindle motor 5 to drive, to thereby rotate the optical disc 10 at predetermined rpm. The drive control unit 3 further controls the sled motor 6 to drive, to thereby move the optical pickup 7 along movement shafts 6A and 6B to a position corresponding to the recording/reproducing address information.

The signal processing unit 4 executes various kinds of processing such as predetermined encoding processing with respect to the supplied recording information, to thereby generate a recording signal, and supplies the recording signal to the optical pickup 7. Further, the signal processing unit 4 executes predetermined demodulating processing and the like with respect to the signal that the optical pickup 7 has read out from the optical disc 10, to thereby generate a reproducing signal, and supplies the reproducing signal to the control unit 2.

The optical pickup 7 is provided to the movement shafts 6A and 6B so as to emit and focus a light on the optical disc 10 from one side.

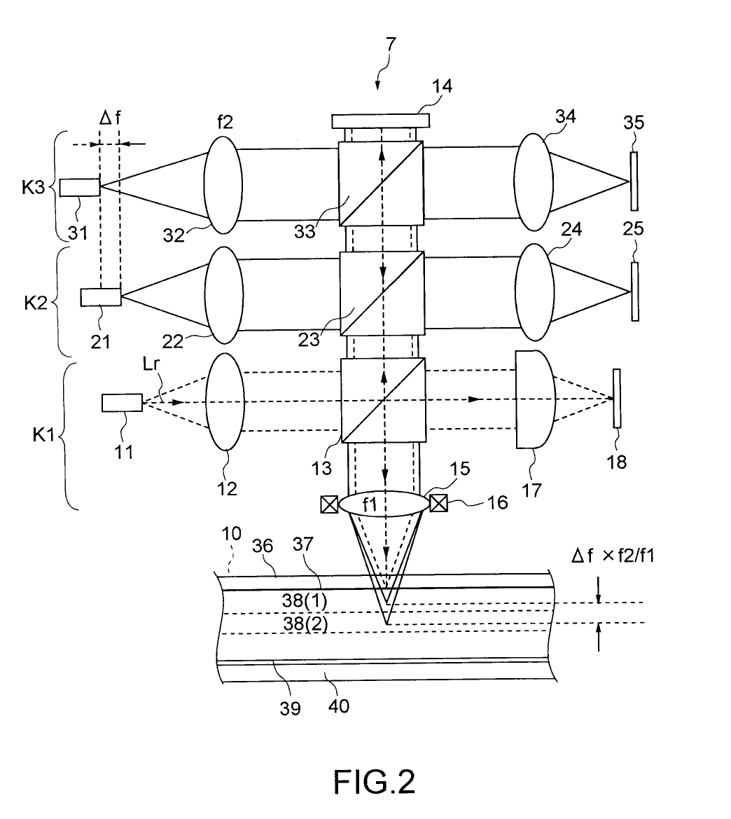

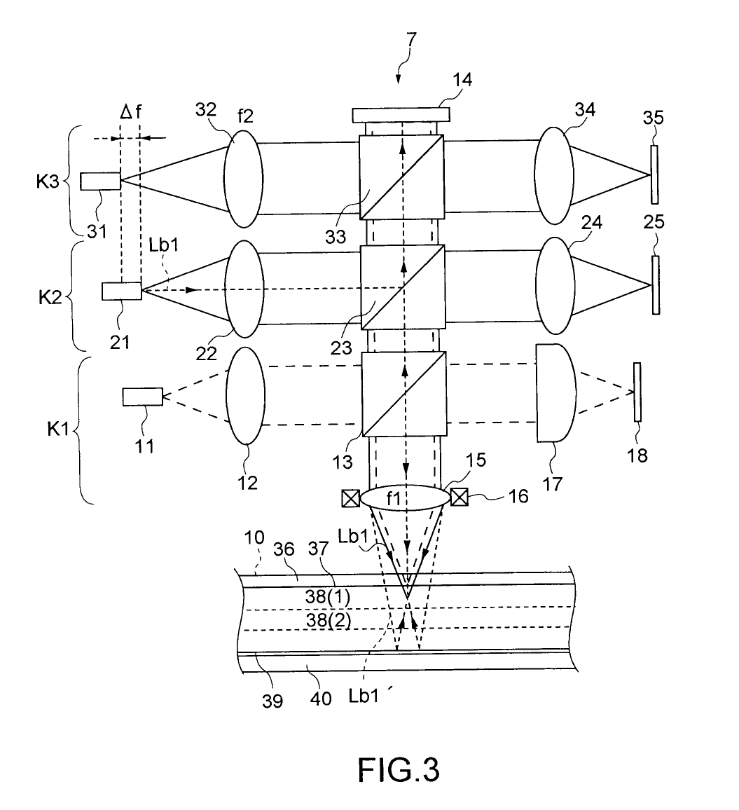

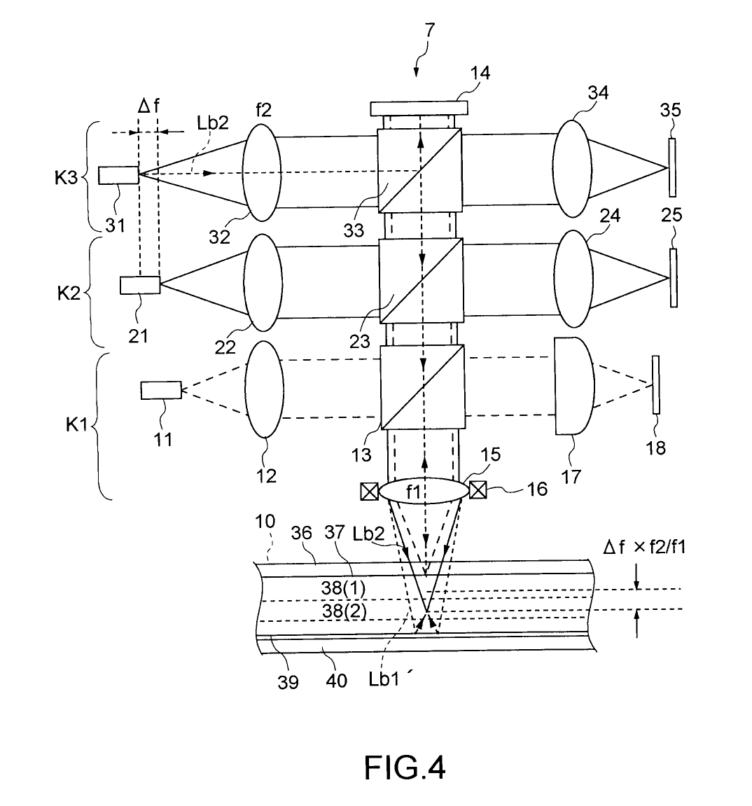

FIG. 2 is a block diagram showing optical systems of the optical pickup 7 of the hologram recording/reproducing apparatus 1. FIG. 3 is an optical path diagram (I) of a blue light beam. FIG. 4 is an optical path diagram (II) of another blue light beam.

(Structure of Optical Pickup 7)

As shown in FIG. 2, the optical systems of the optical pickup 7 include (1) a position control optical system K1, (2) a first information optical system K2, and (3) a second information optical system K3. It should be noted that, in the following description, a mirror 14, an objective lens 15, and a biaxial actuator 16 are shared by those optical systems.

(1) Position Control Optical System K1

The position control optical system K1 mainly controls a position of the objective lens 15, which will be described later, based on a red light beam Lr.

As shown in FIG. 2, the position control optical system K1 includes a laser diode 11, a collimator lens 12, a polarization beam splitter 13, a cylindrical lens 17, and a photodetector 18.

As shown in FIG. 2, the laser diode 11 emits the red light beam Lr having a wavelength of approximately 660 nm. Controlled by the control unit 2, the laser diode 11 emits a predetermined amount of the red light beam Lr, which is a divergent light, to cause the red light beam Lr to enter the collimator lens 12.

The collimator lens 12 converts the red light beam Lr, which is a divergent light, to a parallel light, to cause the red light beam Lr to enter the polarization beam splitter 13.

The polarization beam splitter 13 reflects the red light beam Lr on a reflection surface, to cause the red light beam Lr to enter the mirror 14. The red light beam Lr is reflected by the mirror 14, to thereby enter the objective lens 15.

The objective lens 15 condenses the red light beam Lr, to irradiate the optical disc 10 with the red light beam Lr. Herein, the red light beam Lr passes through a substrate 36, which will be described later, and is reflected by a reflection-transmission layer 37, which will be described later. A focal length of the objective lens 15 is f1. After that, the red light beam Lr reflected by the reflection-transmission layer 37 passes through the objective lens 15, and is then reflected by the reflection surface of the polarization beam splitter 13, to be caused to enter the cylindrical lens 17.

The cylindrical lens 17 irradiates the photodetector 18 with the red light beam Lr such that astigmatism occurs.

In the hologram recording/reproducing apparatus 1, there is a fear in that the rotating optical disc 10 may cause eccentricity, a runout, and the like. This may cause a target track position to change. In order that the red light beam Lr follow a target track, it is necessary to move a focus point in a focus direction and a tracking direction. The focus direction is a direction toward/away from the optical disc 10. The tracking direction is a radial direction toward an inner/outer circumferential side of the optical disc 10. In this case, the objective lens 15 is driven by the biaxial actuator 16 to move in the focus direction and the tracking direction.

The photodetector 18 detects the red light beam Lr. The control unit executes focus control with the astigmatic method, for example, to focus the red light beam Lr on the reflection-transmission layer 37 (focus control). Further, the control unit executes tracking control with the push-pull method, for example, to focus the red light beam Lr on the target track (tracking control).

(2) First Information Optical System K2

As shown in FIG. 3, the first information optical system K2 includes a laser diode 21, a collimator lens 22, a polarization beam splitter 23, a condensing lens 24, a photodetector 25, and the like.

The laser diode 21 emits a blue light beam Lb1 having a wavelength of approximately 405 nm. Controlled by the control unit 2, the laser diode 21 emits a predetermined amount of the blue light beam Lb1, which is a divergent light, to cause the blue light beam Lb1 to enter the collimator lens 22.

The collimator lens 22 converts the blue light beam Lb1, which is a divergent light, to a parallel light, and causes the blue light beam Lb1 to enter the polarization beam splitter 23.

The polarization beam splitter 23 reflects the blue light beam Lb1 with a reflection surface, to cause the blue light beam Lb1 to enter the mirror 14.

The mirror 14 reflects the blue light beam Lb1, to cause the blue light beam Lb1 to enter the objective lens 15. Then, as will be described later, the blue light beam Lb1 is interfered with by a blue light beam Lb1′, to thereby record information (form hologram).

(3) Second Information Optical System K3

As shown in FIG. 4, the second information optical system K3 includes, similar to the first information optical system K2, a laser diode 31, a collimator lens 32, a polarization beam splitter 33, a condensing lens 34, a photodetector 35, and the like. It should be noted that, in a case where the focal length of the objective lens 15 is f1, a focal length of the collimator lens 32 is f2, and a displacement amount of the laser diode 21 and the laser diode 31 is Δf, the focal position in a recording layer 38 of the optical disc 10 is displaced by Δf*f2/f1 (hereinafter, the symbol “*” represents multiplication). As shown in FIG. 4, during recording, the optical path in the second information optical system K3 other than the above is similar to the optical path in the first information optical system K2.

(Structure of Optical Disc)

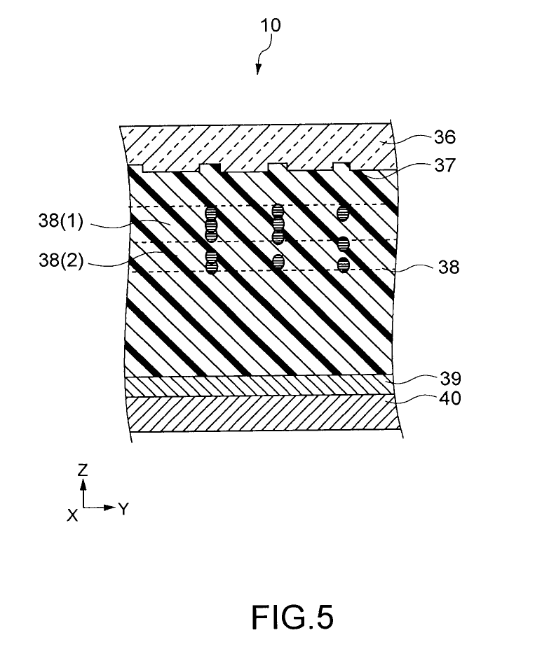

FIG. 5 is a sectional view of the optical disc 10 on which holograms are formed in a manner as described above.

The optical disc 10 is a circular disc having an opening portion (not shown) at a center thereof and having a diameter of approximately 120 mm.

As shown in FIG. 5, the optical disc 10 includes the substrate 36, the reflection-transmission layer 37, the recording layer 38, a reflecting layer 39, and a protection film 40, which are layered in the stated order. Information is recorded on the recording layer 38.

The substrate 36 is made of a material such as polycarbonate or glass. The substrate 36 allows a light entering from one side to pass therethrough toward the other side at a high transmissivity. Further, the substrate 36 has an intensity sufficient to protect the recording layer 38.

The reflection-transmission layer 37 is, for example, a dielectric multilayer. The reflection-transmission layer 37 allows the blue light beam Lb1 whose wavelength is 405 nm to pass therethrough, and reflects the red light beam Lr whose wavelength is 660 nm at a predetermined rate. The reflection-transmission layer 37 is formed on the substrate 36 by, for example, sputtering. As will be described later, the reflection-transmission layer 37 serves as a reference surface (address layer) on which the red light beam Lr is irradiated.

In the recording layer 38, a plurality of recording portions 38(1), 38(2) . . . are layered in a thickness direction (Z direction) of the recording layer 38. In each recording portion, as will be described later, one of “0” to “7” is represented by three present/absent holograms. The plurality of holograms are collectively recorded in the thickness direction of the recording layer 38 such that a physical change thereof can be detected simultaneously. In a case where the information is of six bits, for example, the two recording portions 38(1) and 38(2) constitute one piece of information. According to this embodiment, the holograms are recorded/reproduced on/from the two recording portions 38(1) and 38(2) simultaneously. It should be noted that in the recording portions 38(1) and 38(2) of FIG. 5, an ellipse absent state means a hologram absent state. A horizontal-striped ellipse present state means a hologram present state.

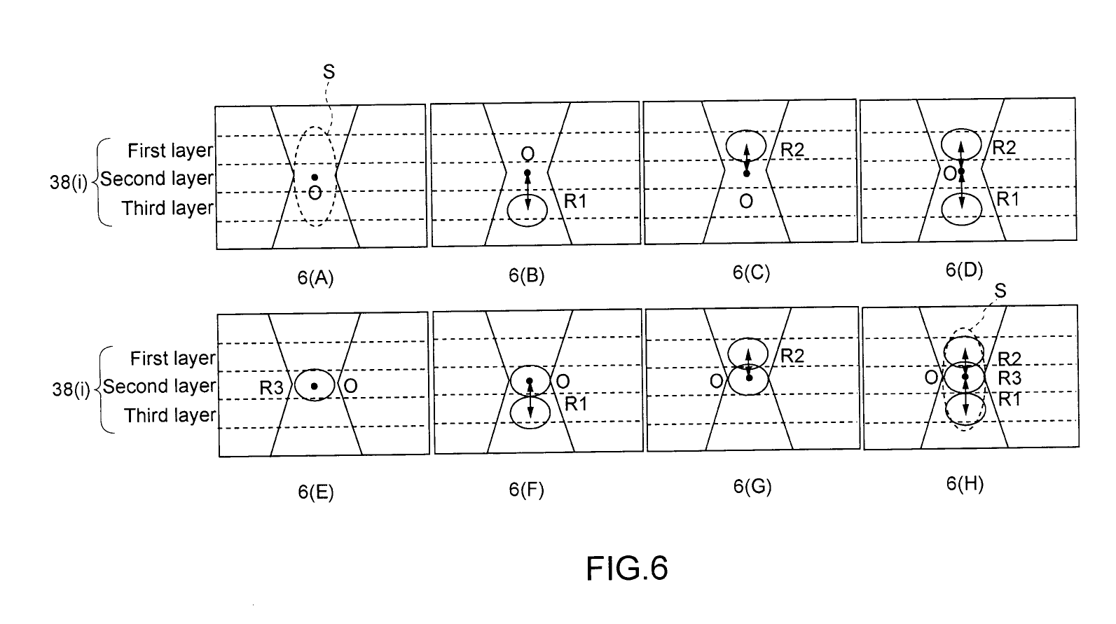

FIGS. 6A to 6H are diagrams illustrating a recording system of three-bit information in the recording portion of FIG. 5.

FIGS. 6A to 6H illustrate the following.

FIG. 6A shows a recording portion 38(i) (i=1, 2 . . . ) whose first layer has no hologram, second layer has no hologram, and third layer has no hologram (000).

FIG. 6B shows the recording portion 38(i) whose first layer has no hologram, second layer has no hologram, and third layer has a hologram (001).

FIG. 6C shows the recording portion 38(i) whose first layer has a hologram, second layer has no hologram, and third layer has no hologram (100).

FIG. 6D shows the recording portion 38(i) whose first layer has a hologram, second layer has no hologram, and third layer has a hologram (101).

FIG. 6E shows the recording portion 38(i) whose first layer has no hologram, second layer has a hologram, and third layer has no hologram (010).

FIG. 6F shows the recording portion 38(i) whose first layer has no hologram, second layer has a hologram, and third layer has a hologram (011).

FIG. 6G shows the recording portion 38(i) whose first layer has a hologram, second layer has a hologram, and third layer has no hologram (110).

FIG. 6H shows the recording portion 38(i) whose first layer has a hologram, second layer has a hologram, and third layer has a hologram (111).

A distance between the hologram formed on the third layer and a center O of a spot S of a light irradiated during reproduction is R1. A distance between the hologram formed on the first layer and the center O of the spot S of the light irradiated during reproduction is R2. A distance between the hologram formed on the second layer and the center O of the spot S of the light irradiated during reproduction is R3. The distance R2 is smaller than the distance R1. The ratio R1:R2 is, for example, 2½:1. The distance R3 is approximately zero.

In the case where the recording portion 38(i) is irradiated with the spot S of the light during reproduction, an amount of a light generated in each hologram of the recording portion 38(i) is inversely proportional to the square of the distance R1, R2, R3. That is, the amounts of lights formed in the holograms of the first layer, the second layer, and the third layer have the ratio of 2:4:1.

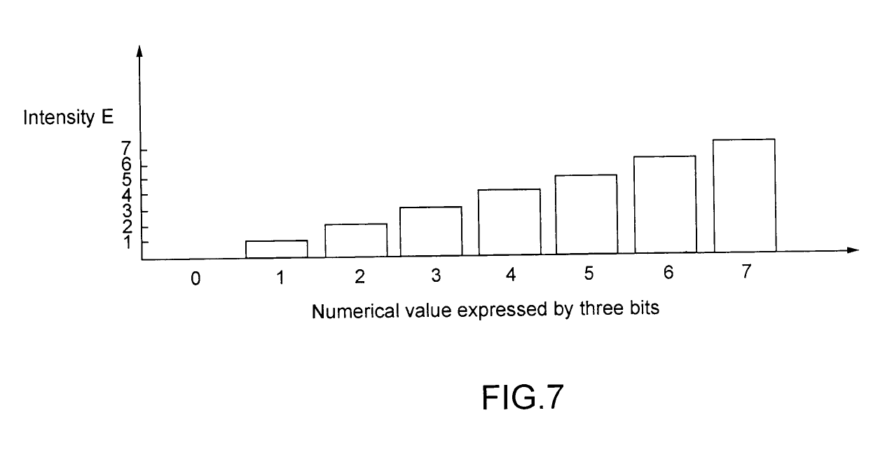

FIG. 7 is a diagram showing a relationship between the numerical value (0 to 7) expressed by three bits and an intensity E of a reproduction light.

For example, in a case where the recording portion 38(i) of FIG. 6A is irradiated with a light, since no hologram is formed thereon, no reproduction light is generated. So, as shown in FIG. 7, the intensity E of the reproduction light becomes zero. Numerical value 0 is thus expressed.

In a case where the recording portion 38(i) having the hologram in the third layer as shown in FIG. 6B is irradiated with a light, a reproduction light having intensity E of 1 as shown in FIG. 7 is generated. Numerical value 1 is thus expressed.

In a case where the recording portion 38(i) having the hologram in the first layer as shown in FIG. 6C is irradiated with a light, a reproduction light having the intensity E of 2 as shown in FIG. 7 is generated. Numerical value 2 is thus expressed.

In a case where the recording portion 38(i) having the holograms in the first and third layers as shown in FIG. 6D is irradiated with a light, a reproduction light having the intensity E of 3 as shown in FIG. 7 is generated. Numerical value 3 is thus expressed.

In a case where the recording portion 38(i) having the hologram in the second layer as shown in FIG. 6E is irradiated with a light, a reproduction light having the intensity E of 4 as shown in FIG. 7 is generated. Numerical value 4 is thus expressed.

In a case where the recording portion 38(i) having the holograms in the second and third layers as shown in FIG. 6F is irradiated with a light, a reproduction light having the intensity E of 5 as shown in FIG. 7 is generated. Numerical value 5 is thus expressed.

In a case where the recording portion 38(i) having the holograms in the first and second layers as shown in FIG. 6G is irradiated with a light, a reproduction light having the intensity E of 6 as shown in FIG. 7 is generated. Numerical value 6 is thus expressed.

In a case where the recording portion 38(i) having the holograms in the first to third layers as shown in FIG. 6H is irradiated with a light, a reproduction light having the intensity E of 7 as shown in FIG. 7 is generated. Numerical value 7 is thus expressed.

Due to a surface state and a surface density of the optical disc 10, there is a limitation to obtain reproduction lights having intensities E distributed in a step-like manner. For compensation, a hologram (not shown) may be provided for redundancy to a deeper layer.

The recording layer 38 is, for example, a photopolymer having a refractive index of 1.5. The thickness of the recording layer 38 is, for example, several hundred μm.

The holograms formed on the plurality of layers of the recording portion 38(i) are provided in the thickness direction (Z direction) of the recording layer 38. For example, the holograms are coaxially provided to the different layers. The three holograms in the first to third layers in each recording portion are provided so as to be superimposed on each other in the thickness direction (Z direction) of the recording layer 38. That is, the length of the recording portion 38(i) for hologram in the thickness direction (Z direction) is smaller than the total thickness of the three holograms.

It should be noted that, in this embodiment, the case where the recording portions 38(1) and 38(2) are formed in the recording layer 38 is exemplarily described. However, the number of the recording portions is not limited to the above, and more than two recording portions may be formed.

Further, the holograms in the first to third layers have substantially the same shape.

The reflecting layer 39 is provided so as to be superimposed on the recording layer 38 and is made of a material such as aluminum or silver. The reflecting layer 39 is formed by, for example, a vacuum deposition method.

The protection layer 40 is provided to the outside of the reflecting layer 39 to secure reliability of the reflecting layer 39, for example.

The optical path of the red light beam Lr during reproduction is similar to the optical path denoted by dotted lines of FIG. 2.

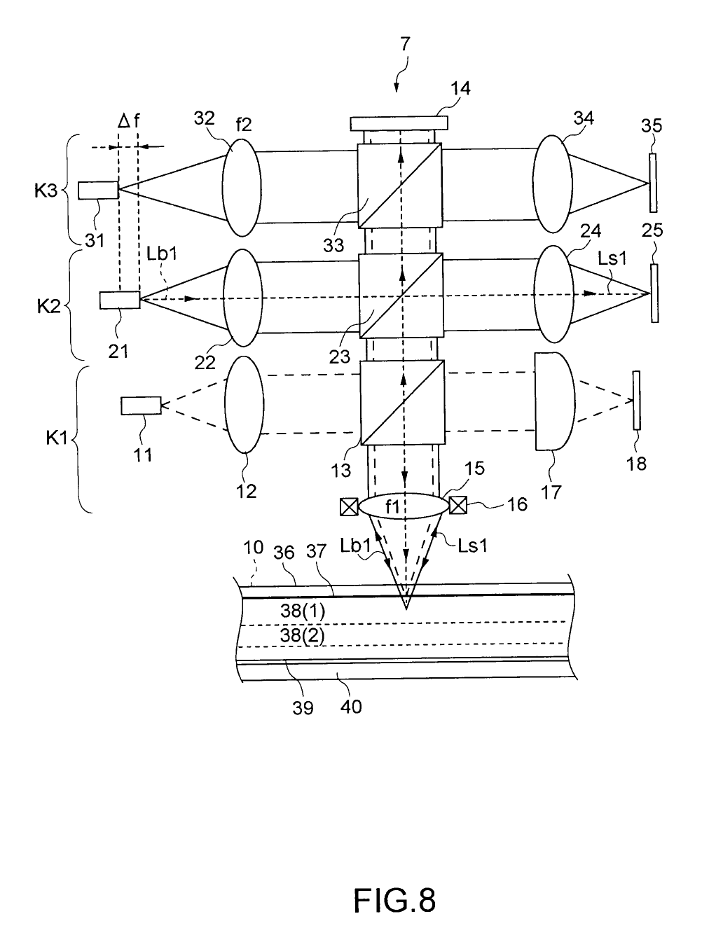

FIG. 8 is an optical path diagram of the blue light beam Lb1 from the laser diode 21 during reproduction.

The objective lens 15 is irradiated with the blue light beam Lb1 from the laser diode 21 in the same manner as shown in FIG. 3, so description will be made of an operation after the irradiation.

The objective lens 15 condenses the blue light beam Lb1, to irradiate the optical disc 10 with the blue light beam Lb1. The spot S of the blue light beam Lb1 does not cover a plurality of tracks of the optical disc 10. The blue light beam Lb1 is emitted on a predetermined track.

Accordingly, for example, the hologram(s) of the recording portion 38(1), as shown in one of FIGS. 6A to 6H, generate(s) a blue reproduction light beam Ls1. An intensity E of the thus generated blue reproduction light beam Ls1 is determined to be one shown in FIG. 7, corresponding to the hologram(s).

Further, in order that the light be irradiated such that the spot S covers a region where the holograms may exist, a numerical aperture NA of the objective lens 15 is adjusted smaller than the numerical aperture NA during recording. The numerical aperture NA is adjusted by, for example, moving the objective lens 15 by the control unit 2, or adjusting an aperture (not shown).

After that, the blue reproduction light beam Ls1 reproduced from the optical disc 10 passes through the objective lens 15, is reflected by the reflection surface of the polarization beam splitter 23, and enters the condensing lens 24.

The condensing lens 24 irradiates the photodetector 25 with the blue reproduction light beam Ls1.

The photodetector 25 detects the blue reproduction light beam Ls1 having one of the weaker to stronger intensities E shown in FIG. 7, and generates a signal corresponding thereto.

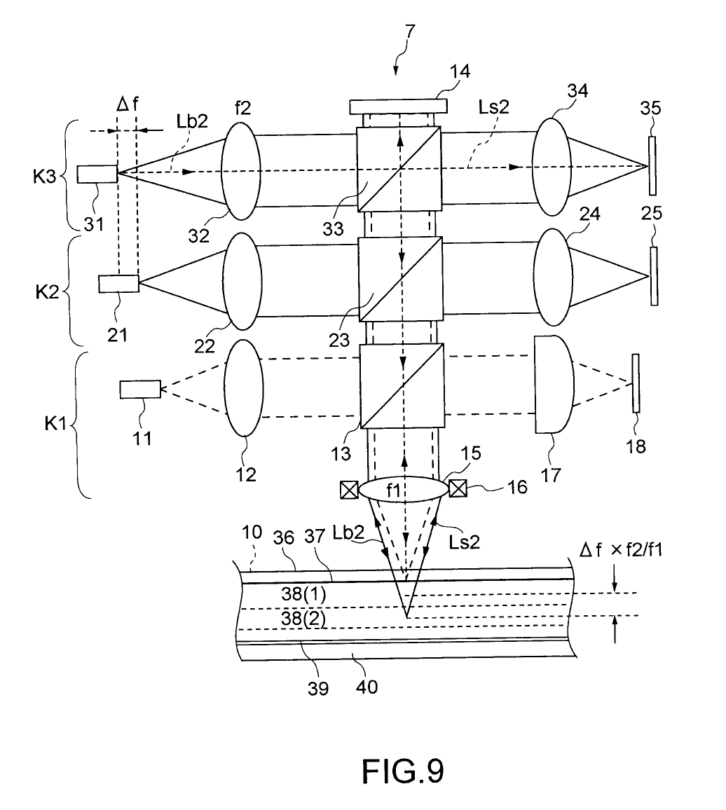

FIG. 9 is an optical path diagram of a blue light beam Lb2 from the laser diode 31 during reproduction.

The objective lens 15 is irradiated with the blue light beam Lb2 from the laser diode 31 in the same manner as shown in FIG. 4, so description will be made of an operation after the irradiation.

The objective lens 15 condenses the blue light beam Lb2, to irradiate the optical disc 10 with the blue light beam Lb2. In this case, the focal position is displaced by Δf*f2/f1 as described above.

Accordingly, for example, the hologram(s) of the recording portion 38(2), as shown in one of FIGS. 6A to 6H, generate(s) a blue reproduction light beam Ls2. An intensity E of the thus generated blue reproduction light beam Ls2 is one shown in FIG. 7, depending on the hologram(s).

Further, in order that the light be irradiated such that the spot S covers a region where the holograms may exist, the numerical aperture NA of the objective lens 15 is adjusted smaller than the numerical aperture NA during recording. The numerical aperture NA is adjusted by, for example, moving the objective lens 15 by the control unit 2, or adjusting the aperture (not shown).

After that, the blue reproduction light beam Ls2 reproduced from the optical disc 10 passes through the objective lens 15, is reflected by the reflection surface of the polarization beam splitter 33, and enters the condensing lens 34.

The condensing lens 34 irradiates the photodetector 35 with the blue reproduction light beam Ls2.

The photodetector 35 detects the blue reproduction light beam Ls2 having one of the weaker to stronger intensities E shown in FIG. 7, and generates a signal corresponding thereto.

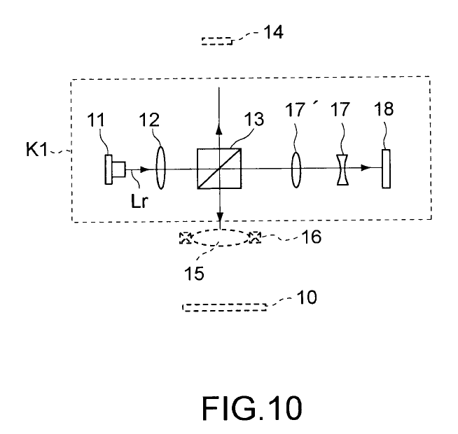

FIG. 10 is a block diagram showing in detail the structure of the position control optical system K1 of FIG. 2.

As shown in FIG. 10, the position control optical system K1 includes the laser diode 11, the collimator lens 12, the polarization beam splitter 13, a condensing lens 171, the cylindrical lens 17, and the photodetector 18.

As shown in FIG. 10, the laser diode 11 emits the red light beam Lr having the wavelength of approximately 660 nm.

The collimator lens 12 converts the red light beam Lr, which is a divergent light, to the parallel light, to cause the red light beam Lr to enter the polarization beam splitter 13.

The polarization beam splitter 13 reflects the red light beam Lr with the reflection surface, to cause the red light beam Lr to enter the mirror 14.

The objective lens 15 condenses the red light beam Lr reflected by the mirror 14, to irradiate the optical disc 10 with the red light beam Lr. Herein, the red light beam Lr passes through the substrate 36, and is reflected by the reflection-transmission layer 37 (see FIG. 2). After that, the red light beam Lr reflected by the reflection-transmission layer 37 passes through the objective lens 15, and is reflected by the reflection surface of the polarization beam splitter 13, to be caused to enter the condensing lens 17′.

The condensing lens 17′ converges the red light beam Lr, to cause the red light beam Lr to enter the cylindrical lens 17.

The cylindrical lens 17 irradiates the photodetector 18 with the red light beam Lr such that astigmatism occurs.

The photodetector 18 detects the red light beam Lr and generates a signal.

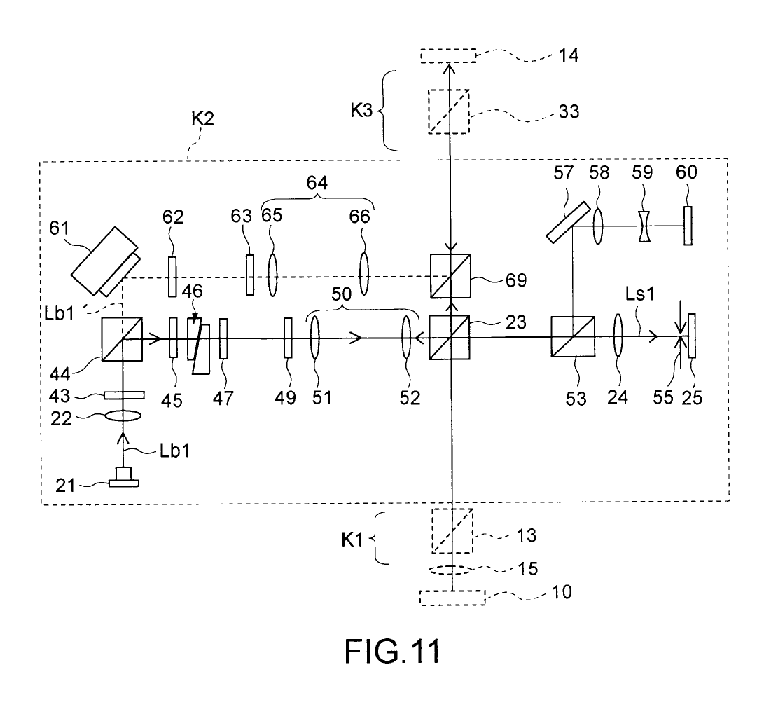

FIG. 11 is a block diagram showing in detail the structure of the first information optical system K2 of FIG. 2.

As shown in FIG. 11, the first information optical system K2 includes the laser diode 21, the collimator lens 22, a half wave plate 43, a polarization beam splitter 44, a shutter 45, an anamorphic prism 46, a half wave plate 47, a quarter wave plate 49, a relay lens system 50, the polarization beam splitter 23, a non-polarization beam splitter 53, the condensing lens 24, a pinhole plate 55 and the photodetector 25, a reflection mirror 57, a condensing lens 58, a cylindrical lens 59, a photodetector 60, a galvano mirror 61, a shutter 62, a quarter wave plate 63, a relay lens system 64, and a polarization beam splitter 69.

The laser diode 21 irradiates the blue light beam Lb1 having the wavelength of approximately 405 nm. Controlled by the control unit 2, the laser diode 21 emits the blue light beam Lb1, which is a divergent light, to cause the blue light beam Lb1 to enter the collimator lens 22. The energy of the light emitted from the laser diode 21 on the hologram(s) on the recording portion 38(1) during reproduction is controlled by the control unit 2 so as not to rewrite information recorded on the hologram(s).

The collimator lens 22 converts the blue light beam Lb1, which is a divergent light, to a parallel light, to cause the blue light beam Lb1 to enter the half wave plate 43.

The half wave plate 43 turns a polarization direction of the blue light beam Lb1 by a predetermined angle such that, for example, the ratio between a p-polarized light component and an s-polarized light component becomes approximately 1:1, to cause the blue light beam Lb1 to enter the polarization beam splitter 44.

The polarization beam splitter 44 reflects the incident blue light beam Lb1 depending on the polarization directions, to cause the blue light beam Lb1 to enter the shutter 45.

Controlled by the control unit 2, the shutter 45 blocks or allows the blue light beam Lb1 to pass therethrough. For example, in the case where the shutter 45 allows the blue light beam Lb1 to pass therethrough, the shutter 45 causes the blue light beam Lb1 to enter the anamorphic prism 46.

The anamorphic prism 46 shapes the incident blue light beam Lb1, to cause the blue light beam Lb1 to enter the half wave plate 47.

The half wave plate 47 turns the polarization direction of the blue light beam Lb1 by a predetermined angle such that, for example, the ratio between the p-polarized light component and the s-polarized light component becomes approximately 1:1, to cause the blue light beam Lb1 to enter the quarter wave plate 49.

The quarter wave plate 49 converts the incident light, which is a linear polarized light (p-polarized light), for example, to a circular polarized light, to cause the light to enter the relay lens system 50.

The relay lens system 50 includes a movable lens 51 and a fixed lens 52. The movable lens 51 converts the blue light beam Lb1, which is a parallel light, to a convergent light. The converged blue light beam Lb1 then becomes a divergent light. The fixed lens 52 converts the blue light beam Lb1, which is now a divergent light, to a convergent light, to cause the blue light beam Lb1 to enter the polarization beam splitter 23.

After that, the blue light beam Lb1 reflected by the polarization beam splitter 23 enters the mirror 14, and is reflected by the mirror 14, to thereby irradiate the objective lens 15 therewith.

The objective lens 15 condenses the blue light beam Lb1, to irradiate the optical disc 10 with the blue light beam Lb1. In this case, the blue light beam Lb1 passes through the substrate 36 and the reflection-transmission layer 37 (see FIG. 8), to thereby irradiate therewith the hologram(s) on the recording portion 38(1), for example.

Accordingly, for example, the hologram(s) of the recording portion 38(1), as shown in one of FIGS. 6A to 6H, generate(s) the blue reproduction light beam Ls1. The intensity E of the thus generated blue reproduction light beam Ls1 is determined to be one shown in FIG. 7, depending on the hologram(s).

After that, the blue reproduction light beam Ls1 generated by the hologram(s) on the reproduction portion 38(1) passes through the objective lens 15 and then the polarization beam splitter 13, to thereby be caused to enter the polarization beam splitter 23.

The polarization beam splitter 23 reflects the blue reproduction light beam Ls1 with the reflection surface, to cause the blue reproduction light beam Ls1 to enter the non-polarization beam splitter 53.

The non-polarization beam splitter 53 causes the incident blue reproduction light beam Ls1 to enter the condensing lens 24. The condensing lens 24 condenses the blue reproduction light beam Ls1, to irradiate the photodetector 25 with the blue reproduction light beam Ls1 via the pinhole plate 55.

The photodetector 25 receives the blue reproduction light beam Ls1 having one of the weaker to stronger intensities E shown in FIG. 7, and generates a signal corresponding thereto.

Further, the non-polarization beam splitter 53 causes the incident blue reproduction light beam Ls1 to enter the reflection mirror 57.

The reflection mirror 57 reflects the incident blue reproduction light beam Ls1, to cause the blue reproduction light beam Ls1 to enter the condensing lens 58.

The condensing lens 58 converges the incident blue reproduction light beam Ls1, to cause the blue reproduction light beam Ls1 to enter the cylindrical lens 59. The cylindrical lens 59 generates astigmatism, to irradiate the photodetector 60 with the blue reproduction light beam Ls1.

Another optical path during reproduction will be described. As shown in FIG. 11, the polarization beam splitter 44 allows a blue light beam Lb1′, which is a part of the blue light beam Lb1 incident from the laser diode 21, to pass through the polarization beam splitter 44, to cause the blue light beam Lb1′ to enter the galvano mirror 61.

The galvano mirror 61 is capable of changing a reflection surface thereof. Controlled by the control unit 2, the galvano mirror 61 adjusts an angle of the reflection surface, to thereby adjust a traveling direction of the blue light beam Lb1′.

Controlled by the control unit 2, the shutter 62 blocks or allows the blue light beam Lb1′ to pass therethrough. For example, in the case where the shutter 62 allows the blue light beam Lb1, to pass therethrough (the shutter 45 is closed), the shutter 62 causes the blue light beam Lb1′ to enter the quarter wave plate 63.

The quarter wave plate 63 converts the incident light, which is a linear polarized light (p-polarized light), for example, to a circular polarized light, to cause the light to enter the relay lens system 64.

The relay lens system 64 includes a movable lens 65 and a fixed lens 66. The movable lens 65 converts the blue light beam Lb1′, which is a parallel light, to a convergent light. The converged blue light beam Lb1′ then becomes a divergent light. The fixed lens 66 converts the blue light beam Lb1′, which is now a divergent light, to a convergent light, to cause the blue light beam Lb1′ to enter the polarization beam splitter 69.

After that, the blue light beam Lb1′ reflected by the polarization beam splitter 69 enters the mirror 14, and is reflected by the mirror 14, to thereby enter the objective lens 15. The optical path thereafter is the same as the above. During reproduction, the optical path of the blue light beam Lb1 or Lb1′ is used. It should be noted that the same is applied to the second information optical system K3. Further, during recording, the optical paths of both the blue light beams Lb1 and Lb1′ are used.

It should be noted that the blue reproduction light beam Ls2 also enters the photodetector 25, and the blue reproduction light beam Ls1 also enters the photodetector 35. When the focal length of the condensing lens 24, 34 is adjusted (optimized), the output from the photodetector 25, 35 decreases in proportion with the square of the distance, which hardly causes any problem.

Subsequently, description will be made on a case where a hologram is formed on the reproduction portion 38(1).

The blue light beam Lb1 emitted from the laser diode 21 travels along the path shown in FIG. 11, to thereby be condensed on a predetermined position (position where a hologram is formed) on the recording layer 38 of the optical disc 10 (see FIG. 3).

Meanwhile, the relay lens system 64 and the like adjust the focal position of the blue light beam Lb1′, which is emitted from the laser diode 21 and separated by the polarization beam splitter 44 of FIG. 11. The polarization beam splitter 69 polarizes the blue light beam Lb1′, to cause the blue light beam Lb1′ to enter the objective lens 15 (see FIG. 3).

The objective lens 15 irradiates the optical disc 10 with the blue light beam Lb1′. In this case, as shown in FIG. 3, the reflecting layer 39 reflects the blue light beam Lb1′. The reflected light overlaps the focus point of the blue light beam Lb1, with the result that interference of the lights occurs. Further, by adjusting positions of the lenses of the relay lens systems and the like through which the blue light beams Lb1 and Lb1′ pass, respectively, the numerical aperture NA of each lens is adjusted to be larger than that during reproduction. Depth of focus is thus reduced, whereby the interference occurs at a correct position. As a result, a hologram is formed at the position where the interference occurs. A plurality of holograms can be formed simultaneously in the same manner.

According to this embodiment, as described above, the hologram recording/reproducing apparatus 1 includes the first information optical system K2 having the laser diode 21, the photodetector 25, and the like, and the second information optical system K3 having the laser diode 31, the photodetector 35, and the like. With this structure, the laser diode 21 can irradiate the recording portion 38(1) of the optical disc 10 of FIG. 5 with the blue light beam Lb1 such that the spot S of the blue light beam Lb1 covers a plurality of holograms. So, the plurality of holograms on the recording portion 38(1) is irradiated with the blue light beam Lb1 with one spot S simultaneously. A plurality of different reproduction lights generated by the plurality of holograms can be detected as one blue reproduction light beam Ls1.

As a result, the intensity E of the blue reproduction light beam Ls1 can be varied as shown in FIG. 7, corresponding to the holograms of FIGS. 6A to 6H. That is, for example, information of three bits can be obtained from the recording portion 38(1) with one spot S of the blue reproduction light beam Lb1 during reproduction. By simultaneously emitting the blue light beam Lb2 from the laser diode 31 on the recording portion 38(2), in addition to the obtainment of the information of three bits from the recording portion 38(1), information of three bits can be simultaneously obtained from the recording portion 38(2). So, compared to a past case where information of one bit is detected with one spot of a blue light beam, information can be reproduced at higher speed according to this embodiment.

Further, the plurality of holograms on the recording portion 38(1) overlap each other in the thickness direction (Z direction) of the recording layer 38. With this structure, a space on which information is recorded can be downsized in the thickness direction. So, compared to a past case where a plurality of holograms are apart from each other in a thickness direction of a recording layer, recording density can be increased according to this embodiment. Thus, the optical disc 10 can be made thinner. In this case, a problem of aberration, which is generated when an optical disc is thick, can be addressed.

Further, for example, the first information optical system K2 can form a hologram on the recording portion 38(1) of the optical disc 10 as shown in FIG. 3. At the same time, as shown in FIG. 4, the second information optical system K3 can form a hologram on the recording portion 38(2) just below the hologram formed on the recording portion 38(1) described above. Accordingly, recording of a large amount of data can be performed at high speed.

Further, although the recording portion 38(1) of the recording layer 38 has a plurality of holograms, no address layer for obtaining an address of data is provided between, for example, the plurality of holograms. Thus, when simultaneously reading out data items of the holograms, for example, lights generated by the holograms are not affected by the address layer and are not deteriorated.

Further, in the hologram recording/reproducing apparatus 1, during reproduction, by moving the objective lens 15, for example, the numerical aperture NA thereof is reduced. Herein, the blue light beam Lb1 can be irradiated on the recording portion 38(i) such that the spot S thereof covers the holograms as shown in FIG. 6H. Further, during recording, by moving the objective lens 15, the numerical aperture NA thereof is increased, to thereby reduce the depth of focus. That is, data is recorded by condensing the light on the optical disc 10 at a higher light condensing rate than a light condensing rate during reproduction. Accordingly, a hologram can be formed at a correct position.

### Second Embodiment

Subsequently, an optical disc apparatus according to a second embodiment of the present invention will be described. It should be noted that, in the following embodiments, structural components and the like similar to those of the first embodiment described above are denoted by similar reference symbols, and description thereof will be omitted. Portions different from the first embodiment will mainly be described.

(Structure of Optical Disc Apparatus)

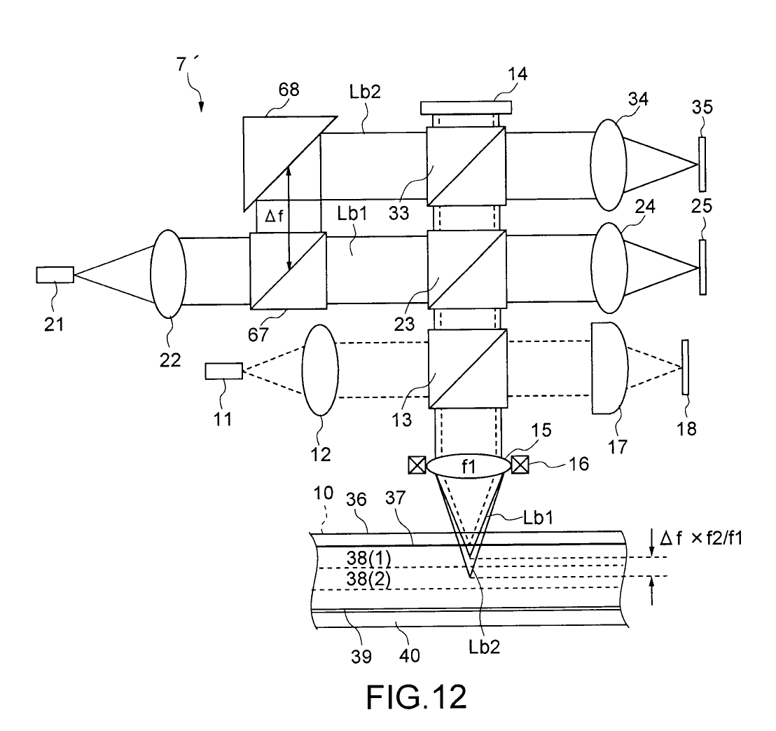

FIG. 12 is a block diagram showing optical systems of an optical pickup of the optical disc apparatus according to the second embodiment.

The optical disc apparatus according to this embodiment includes an optical pickup 7′ of FIG. 12 instead of the optical pickup 7 according to the first embodiment.

As shown in FIG. 12, the optical pickup 7′ does not include the laser diode 31 of FIG. 2. The optical pickup 7′ includes a beam splitter 67 and a mirror 68. The beam splitter 67 is provided between the collimator lens 22 and the polarization beam splitter 23.

The beam splitter 67 splits the blue light beam Lb1 parallelized by the collimator lens 22 to cause the split blue light beams to enter the polarization beam splitter 23 and the mirror 68.

The distance between the mirror 68 and the beam splitter 67 is Δf. The mirror 68 reflects the incident blue light beam, denoted by Lb2, to cause the blue light beam Lb2 to enter the polarization beam splitter 33.

(Optical Path (I) of Blue Light Beam)

The laser diode 21 emits the blue light beam Lb1, to cause the blue light beam Lb1 to enter the collimator lens 22. The collimator lens 22 converts the incident blue light beam Lb1 to a parallel light, to cause the blue light beam Lb1 to enter the beam splitter 67.

The beam splitter 67 partially allows the incident blue light beam Lb1 to pass therethrough, to cause the blue light beam Lb1 to enter the polarization beam splitter 23 in the similar manner to the first embodiment. The blue light beam Lb1 that enters the polarization beam splitter 23 travels along the optical path similar to the optical path of FIG. 8, to enter the hologram on the recording portion 38(1).

(Light Path (II) of Blue Light Beam)

The beam splitter 67 partially reflects the incident blue light beam Lb1, to cause the reflected blue light beam, denoted by Lb2, to enter the mirror 68.

The mirror 68 reflects the incident blue light beam Lb2, to cause the blue light beam Lb2 to enter the polarization beam splitter 33 similar to the first embodiment. The blue light beam Lb2 that enters the polarization beam splitter 33 travels along the optical path similar to the optical path of FIG. 9, to enter the hologram on the recording portion 38(2).

As described above, the optical disc apparatus of this embodiment does not include the laser diode 31 of FIG. 2. Instead, the optical disc apparatus of this embodiment includes one laser diode 21 as shown in FIG. 21. That is, it is not necessary to provide a plurality of laser diodes, so the cost can be reduced. Further, the optical disc apparatus of this embodiment includes the beam splitter 67 for splitting the blue light beam Lb1 irradiated from the laser diode 21. So the beam splitter 67 splits the blue light beam Lb1 emitted from the laser diode 21, to irradiate the holograms on the plurality of recording portions 38(1) and 38(2) with the split blue light beams to simultaneously reproduce/record information.

### Third Embodiment

Subsequently, an optical disc apparatus according to a third embodiment of the present invention will be described.

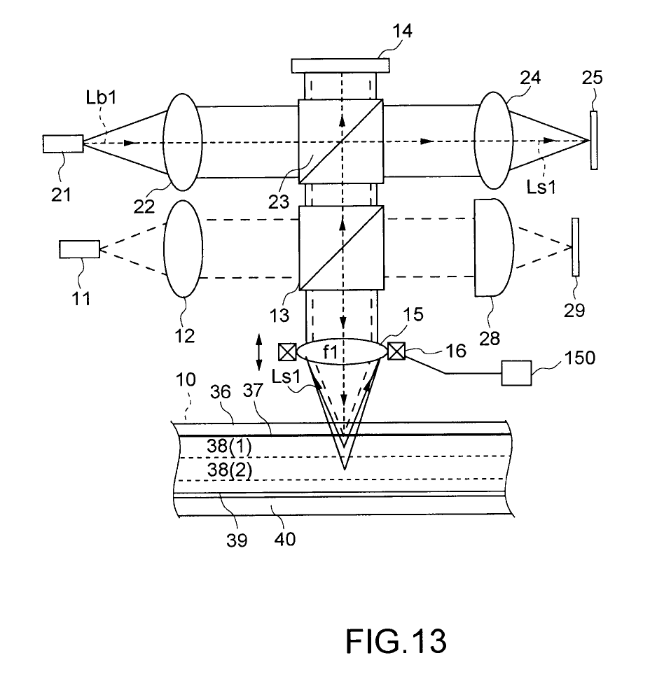

FIG. 13 is a block diagram showing optical systems of an optical pickup of the optical disc apparatus according to the third embodiment.

The optical pickup of this embodiment is similar to the optical pickup of the first embodiment except that the optical pickup of this embodiment does not include the second information optical system K3 (including the laser diode 31, the collimator lens 32, the polarization beam splitter 33, the condensing lens 34, the photodetector 35, and the like) of FIG. 2.

Further, the biaxial actuator 16 of this embodiment includes a voice coil motor. The optical pickup of this embodiment includes a signal generator 150 for generating a signal to be transmitted to the voice coil motor. The biaxial actuator 16 including the voice coil motor and the signal generator 150 adjust the position of the spot of the blue light beam Lb1 at high speed during recording/reproduction. A piezoelectric device may alternatively be used as a power source for the biaxial actuator 16.

The signal generator 150 generates a signal for driving the voice coil motor at high speed. Preferably, the signal is a sine wave signal or a triangular wave signal, for example.

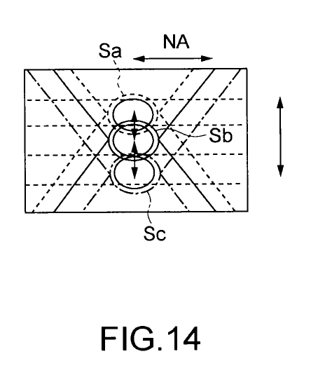

FIG. 14 is a diagram illustrating a light spot during recording/reproduction according to the third embodiment of the present invention.

During recording, controlled by the control unit 2, the signal generator 150 generates a signal, which is supplied to the voice coil motor. Then, the biaxial actuator 16 is driven, to cause the objective lens 15 to move in the thickness direction of the recording layer 38 at high speed. The focal position is thus adjusted. As shown in FIG. 14, for example, two blue light beams are interfered with each other on a spot Sa, to record a hologram on the first layer at high speed. In a similar manner, the focal position is further moved at high speed. Two blue light beams are interfered with each other on a spot Sb, to record a hologram on the second layer. In a similar manner, the focal position is further moved at high speed. Two blue light beams are interfered with each other on a spot Sc, to record a hologram on the third layer (high-speed scanning system).

During reproduction, controlled by the control unit 2, the objective lens 15 is caused to move in the thickness direction of the recording layer 38 at high speed. Accordingly, as shown in FIG. 14, the focal position is adjusted at high speed. For example, the holograms is irradiated with a blue light beam, and the hologram can be reproduced at high speed while the numerical aperture NA maintaining the same large value as that during recording without being changed (high-speed scanning system).

### Fourth Embodiment

Subsequently, an optical disc apparatus according to a fourth embodiment of the present invention will be described.

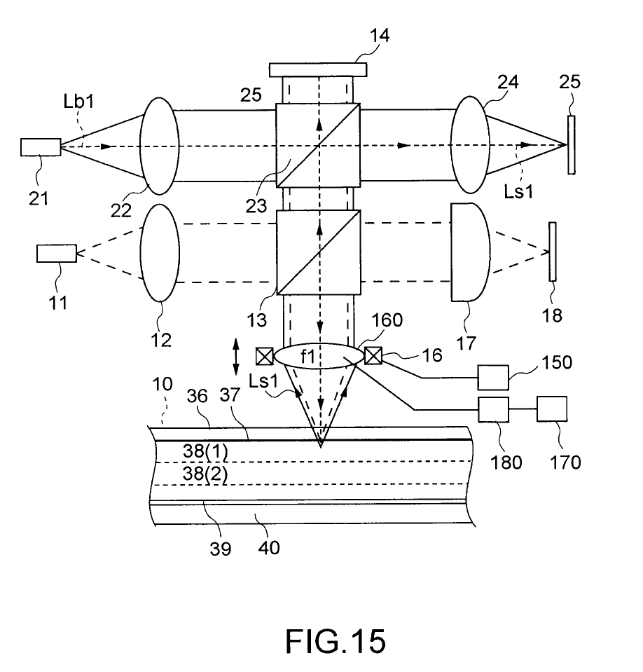

FIG. 15 is a block diagram showing optical systems of an optical pickup of the optical disc apparatus according to the fourth embodiment.

The optical pickup of this embodiment is similar to the optical pickup of the third embodiment except that the optical pickup of this embodiment includes a liquid lens 160 instead of the objective lens 15, a signal generator 170 for generating a signal for applying a voltage to the liquid lens 160, and an amplifier 180 for amplifying the signal generated by the signal generator 170.

With the application of a voltage, for example, a liquid in the liquid lens 160 is transformed, whereby a refractive index can be changed.

Accordingly, controlled by the control unit 2, the signal generator 170 generates a signal. The amplifier 180 amplifies the signal, which is applied to the liquid lens 160. As a result, the liquid in the liquid lens 160 is transformed (e.g., expanded/contracted at high speed), to change a refractive index of a light that entered the liquid lens 160. A focal length of the liquid lens 160 can thus be adjusted. Accordingly, recording/reproduction can be performed with a focus point adjusted at a predetermined position.

In this case, for example, it is possible to employ the biaxial actuator 16 to adjust a fluctuation of the optical disc 10, and to employ the liquid lens 160 to adjust the focal position. That is, the biaxial actuator 16 and the liquid lens 160 can independently be used, thereby enabling more stable control at higher speed.

The present invention is not limited to the embodiments described above. It should be understood by those skilled in the art that various modifications, combinations, sub-combinations and alterations may occur depending on design requirements and other factors insofar as they are within the scope of the appended claims or the equivalents thereof.

For example, in order to adjust the focal position, a high-speed modulator such as an acousto-optic modulator (AOM) may be used instead of the objective lens 15.

Further, in the above embodiments, as shown in FIGS. 6A to 6H, three-bit information is expressed in the three layers of the recording portion 38(1). However, the present invention is not limited to this example. Alternatively, two-bit information may be expressed in the three layers by employing a recording system of two-bit information of FIGS. 6A to 6D. In this case, for example, it is only necessary to count the number of holograms on the recording portion 38(1).

Further, in the above embodiments, a hologram(s) is/are formed on the recording layer 38 by causing two lights to interfere with each other. Alternatively, the recording layer 38 may be subjected to thermal processing, to thereby change a refractive index to record information. Also, in this case, only by heating the recording layer 38, information can easily be recorded on the recording layer 38. An irradiation time period and a thermal energy of a light emitted on a portion, which is subjected to thermal processing and has a refractive index having been changed, from the laser diode during reproduction are to be controlled by the control unit 2 so as not to rewrite the recorded information. Accordingly, even though the light is irradiated on the portion, which is subjected to thermal processing and has the refractive index having been changed, during reproduction, by controlling the irradiation time period and the thermal energy of the light, the recorded information can be prevented from being rewritten.

What is claimed is:

1. A recording apparatus for recording data on a recording medium having at least one recording layer, comprising:
a loading unit on which the recording medium is capable of being loaded; and
a recorder unit configured to cause the at least one recording layer a physical change to collectively record a plurality of pieces of data on the at least one recording layer of the recording medium loaded on the loading unit, in a thickness direction of the at least one recording layer, such that the physical change of the at least one recording layer is capable of being detected at one time when the recording medium is reproduced.

2. The recording apparatus according to claim 1,
wherein the recorder unit is configured to cause the at least one recording layer the physical change by forming holograms, to record the plurality of pieces of data.

3. The recording apparatus according to claim 2,
wherein each of the plurality of pieces of data is expressed by one of hologram presence and hologram absence.

4. The recording apparatus according to claim 3,
wherein the plurality of pieces of data collectively recorded constitute one information unit.

5. The recording apparatus according to claim 3,
wherein the recorder unit is configured to cause the at least one recording layer the physical change by subjecting the at least one recording layer to thermal processing to form the holograms, to record the plurality of pieces of data.

6. The recording apparatus according to claim 1,
wherein the recorder unit is configured to cause the at least one recording layer the physical change by focusing a light on the recording medium at a higher light focusing rate than a light focusing rate in a case of reproducing the plurality of pieces of data, to record the plurality of pieces of data.

7. The recording apparatus according to claim 1,
wherein the recorder unit includes a laser light source for the plurality of pieces of data collectively recorded.

8. The recording apparatus according to claim 1,
wherein the recorder unit includes a laser light source configured to emit a laser light, an optical system configured to focus the laser light on the recording medium, and a drive control unit for the optical system, the drive control unit being configured to move a focus point of the laser light at high speed to collectively record the plurality of pieces of data on the recording medium.

9. The recording apparatus according to claim 8,
wherein the optical system includes an objective lens, and
wherein the drive control unit is configured to move the objective lens at high speed to move the focus point at high speed.

10. The recording apparatus according to claim 8,
wherein the optical system includes a liquid lens serving as an objective lens, and
wherein the drive control unit is configured to expand/contract the liquid lens at high speed to move the focus point at high speed.

11. The recording apparatus according to claim 8,
wherein the optical system includes a high-speed modulator, and
wherein the drive control unit is configured to drive the high-speed modulator to move the focus point at high speed.

12. A reproducing apparatus for reproducing data recorded on at least one recording layer of a recording medium, comprising:
a loading unit on which the recording medium is capable of being loaded, the at least one recording layer of the recording medium loaded on the loading unit being caused a physical change such that a plurality of pieces of data are collectively recorded on the at least one recording layer in a thickness direction of the at least one recording layer; and
a detection unit configured to simultaneously read the plurality of pieces of data, and configured to detect the physical change of the at least one recording layer collectively recorded with the plurality of pieces of data having been read.

13. The reproducing apparatus according to claim 12,
wherein each of the plurality of pieces of data, the plurality of pieces of data being collectively recorded on the at least one recording layer of the recording medium in the thickness direction of the at least one recording layer, is expressed by one of hologram presence and hologram absence, and
wherein the detection unit is configured to detect the physical change by detecting a signal intensity, to detect, based on the signal intensity, the plurality of pieces of data each expressed by the one of hologram presence and hologram absence.

14. The reproducing apparatus according to claim 13,
wherein the detection unit includes a laser light source configured to emit a laser light, and an optical system configured to focus the laser light on the recording medium such that the laser light is focused on the plurality of pieces of data collectively recorded on the at least one recording layer of the recording medium, in the thickness direction of the at least one recording layer.

15. The reproducing apparatus according to claim 14,
wherein the recording medium includes a plurality of tracks, and
wherein the optical system focuses the laser light on the plurality of pieces of data collectively recorded on the at least one recording layer such that one of the plurality of tracks of the recording medium is focused on.

16. A recording method of recording data on a recording medium including at least one recording layer, comprising:
loading the recording medium on a loading unit; and
collectively recording a plurality of pieces of data on the at least one recording layer of the recording medium loaded on the loading unit, in a thickness direction of the at least one recording layer, such that a physical change of the at least one recording layer is capable of being detected at one time when the recording medium is reproduced.

17. A reproducing method of reproducing data recorded on at least one recording layer of a recording medium, comprising:
loading the recording medium on a loading unit, the at least one recording layer of the recording medium being caused a physical change such that a plurality of pieces of data are collectively recorded on the at least one recording layer in a thickness direction of the at least one recording layer; and
simultaneously reading the plurality of pieces of data, and detecting the physical change of the at least one recording layer collectively recorded with the plurality of pieces of data having been read.

18. A recording medium, comprising:
at least one recording layer on which a plurality of pieces of data are capable of being collectively recorded, in a thickness direction of the at least one recording layer, such that a physical change of the at least one recording layer is capable of being detected at one time when the recording medium is reproduced.

19. The recording medium according to claim 18,
wherein the plurality of pieces of data, the plurality of pieces of data being collectively recorded on the at least one recording layer in the thickness direction of the at least one recording layer such that the physical change of the at least one recording layer is capable of being detected at one time when the recording medium is reproduced, constitute one information unit.
